(19) United States
(12) Patent Application Publication
(10) Pub. No.: US 2024/0124986 A1
(43) Pub. Date: Apr. 18, 2024

(54) METHOD FOR PRODUCING ALKALI METAL/ALKALINE EARTH METAL HYDROXIDE AND APPLICATION OF SAID PRODUCTION METHOD TO CARBOXYLATE WASTE RECYCLING TECHNOLOGY

(71) Applicant: TOHOKU UNIVERSITY, Sendai-shi, Miyagi (JP)

(72) Inventors: Kousuke HIROMORI, Sendai-shi, Miyagi (JP); Naomi KITAKAWA, Sendai-shi, Miyagi (JP); Keisuke KATAGAMI, Sendai-shi, Miyagi (JP)

(73) Assignee: TOHOKU UNIVERSITY, Sendai-shi, Miyagi (JP)

(21) Appl. No.: 18/276,314

(22) PCT Filed: Feb. 21, 2022
(86) PCT No.: PCT/JP2022/007032

§ 371 Date: Aug. 8, 2023

(30) Foreign Application Priority Data
Mar. 5, 2021 (JP) 2021-035809

(51) Int. Cl. C25B 1/16; C01D 1/04; C02F 1/461; C11B 3/06; C25B 9/19; D21C 3/02; D21C 11/04

(52) U.S. Cl. CPC C25B 1/16; C01D 1/04; C02F 1/46104; C11B 3/06; C25B 9/19; D21C 3/02; D21C 11/04; C02F 2103/322; C02F 2201/46115

(57) ABSTRACT

A method for producing an alkali metal/alkaline earth metal hydroxide includes: subjecting a solution containing R^{A}—COOM^{B} and/or (R^{A}—COO)₂M^{C} and water to an electrochemical reaction to cause a Kolbe electrolysis reaction at an anode to generate at least R^{A}—R^{A}, carbon dioxide, and an M^{B+} ion and/or M^{C2+} ion; and neutralizing the M^{B+} ion and/or M^{C2+} ion by using an OH⁻ ion generated by electrolysis of water at a cathode. R^{A} represents a hydrocarbon group, M^{B} represents an alkali metal, and M^{C} represents an alkaline earth metal.

### TECHNICAL FIELD

The present invention relates to a method for producing an alkali metal/alkaline earth metal hydroxide and an application of said production method to a carboxylate waste recycling technology.

### BACKGROUND ART

Vegetable oils and fats are produced by compressing vegetable raw materials such as soybeans or rapeseeds to extract a crude oil, and subjecting the crude oil to various processes such as degumming, deacidification, decolorization, and deodorization (see FIG. 1). In the deacidification process, an alkali metal hydroxide such as caustic soda (NaOH) is added to convert a fatty acid into a fatty acid salt, and the fatty acid salt is precipitated to separate and remove the fatty acid salt from the oils and fats. A fraction containing the removed fatty acid salt generally contains about 30 mass % to 60 mass % of the fatty acid salt, about 30 mass % to 50 mass % of water, and about 10 mass % to 30 mass % of other oils and fats, and is called a soapstock (foots). The soapstock is generated at a proportion of 0.5 mass % to 20 mass % with respect to a production amount of the vegetable oils and fats.

The soapstock contains moisture, exhibits an alkaline property, and is in a form of a high-viscosity paste, and is thus often discarded as a waste due to poor handleability. On the other hand, due to a large number of the soapstock generated, effective utilization of the soapstock has also been studied. For example, it has been proposed to add sulfuric acid to the soapstock for acid decomposition, and then distill a fraction called a dark oil to obtain a fatty acid. Further, it is also studied to use the soapstock as a fuel. For example, PTL 1 discloses that a soapstock generated as a byproduct in a deacidification process is neutralized with an acid, the neutralized soapstock is dried, the dried neutralized soapstock is mixed with an undried neutralized soapstock, and the mixed soapstock is controlled to have appropriate fluidity and mixed with a fossil fuel to give a fuel.

However, reuse as the fatty acid is limited to reuse of the dark oil fraction obtained from the soapstock, and an aqueous residue containing sodium ions is discarded. Further, in the method described in PTL 1, the soapstock is subjected to a certain treatment and then used as a fuel, which is laborious and costly to prepare. On the other hand, there is a problem that when the soapstock is incinerated as a fuel as it is, a boiler is damaged by alkalis or is clogged by incombustible salts in the incineration residue.

Effective utilization of carboxylates is desired not only in the above vegetable oils and fats industry but also in other industries. For example, in production of a fatty acid ester, an edible oil or the like is reacted with an alcohol such as methanol in presence of an alkali catalyst such as caustic soda or caustic potash to give a fatty acid ester, which is used as a biodiesel fuel or the like (see FIG. 2). The crude fatty acid ester fraction obtained by a reaction of the edible oil and the alcohol contains a fatty acid salt as an impurity, and the fatty acid salt is transferred into washing water in a washing process for the crude fatty acid ester fraction, and is discarded as soap wastewater.

Further, in a papermaking process, wood chips are put into a digester, and a chemical agent containing an alkali metal hydroxide such as caustic soda, or an alkaline earth metal such as calcium hydroxide is added to the digester, followed by simmering to dissolve (digest) lignin and extract cellulose fibers, and the extracted cellulose fibers are washed to remove lignin and bleached to give papers, pulps, cellulose nanofibers, and the like (see FIG. 3). In the washing process after the digestion, a black liquid in which lignin or the like is dissolved is generated. The black liquid contains a large number of salts of cinnamic acids (cinnamic acid, sinapinic acid, coumaric acid, caffeic acid, and the like), which are lignin decomposition products.

Use of a carboxylic acid or a salt thereof as a hydrocarbon source instead of petroleum has been proposed. For example, PTL 2 discloses that a fatty acid or a salt thereof obtained by hydrolyzing oils and fats is subjected to a Kolbe electrolysis reaction to generate a hydrocarbon at an anode. The Kolbe electrolysis reaction is a long-known electrochemical organic synthesis reaction for hydrocarbons. In the Kolbe electrolysis reaction, a conjugated anion of the fatty acid is decarboxylated while being subjected to one electron oxidation at an anode electrode and an aliphatic chain of the fatty acid is converted into a dimer, to give a hydrocarbon.

### CITATION LIST

### Patent Literature

PTL 1: JP6594617B
PTL 2: JP2017-527682A

### SUMMARY OF INVENTION

### Technical Problem

An object of the invention is to provide a technology capable of effectively utilizing a solution containing a fatty acid or a salt of a derivative thereof and water as a hydrocarbon source, but also substantially the entire solution as a resource without a particularly complicated operation.

### Solution to Problem

The above problem of the invention is solved by the following methods.

[1]

A method for producing an alkali metal/alkaline earth metal hydroxide (M^{B}-OH/M^{C}-(OH)₂) including: subjecting a solution containing R^{A}—COOM^{B} and/or (R^{A}—COO)₂M^{C} and water to an electrochemical reaction to cause a Kolbe electrolysis reaction at an anode to generate at least R^{A}—R^{A}, carbon dioxide, and an M^{B+} ion and/or M^{C2+} ion; and neutralizing the M^{B+} ion and/or M^{C2+} ion by using an OH⁻ ion generated by electrolysis of water at a cathode, in which

R^{A} represents a hydrocarbon group, M^{B} represents an alkali metal, and M^{C} represents an alkaline earth metal.

[2]

The production method according to [1], in which the solution containing R^{A}—COOM^{B} and/or (R^{A}—COO)₂M^{C} and water contains at least one waste solution of the following (a) to (c),

(a) a soapstock generated in a deacidification process in production of vegetable oils and fats,

(b) a black liquid generated in a washing process after digestion in papermaking, and

(c) soap wastewater generated in a washing process for a crude fatty acid ester fraction in production of a fatty acid ester.

[3]

The production method according to [1] or [2], in which a reaction solution containing M^{B}-OH and/or M^{C}-(OH)₂ generated by the neutralization is put into one side of a cell whose inside is separated by an ion-permeable membrane, water is put into the other side of the cell separated by the membrane, and the M^{B}-OH and/or M^{C}-(OH)₂ is transferred into the water.

[4]

The production method according to [1] or [2], in which in the electrochemical reaction, an electrolytic cell is separated by an ion-permeable membrane.

[5]

The production method according to [4], in which an anode side and a cathode side are separated by the membrane, the solution containing R^{A}—COOM^{B} and/or (R^{A}—COO)₂M^{C} and water is put into the anode side, water is put into the cathode side, and the electrochemical reaction is performed.

[6]

The production method according to [4], in which in the electrochemical reaction, the anode and the cathode are disposed on one side of the electrolytic cell separated by the membrane, M^{B}-OH and/or M^{C}-(OH)₂ is generated in a reaction solution by the electrochemical reaction, water is put into the other side of the electrolytic cell separated by the membrane, and the M^{B}-OH and/or M^{C}-(OH)₂ is transferred into the water.

[7]

The production method according to any one of [3] to [6], in which the membrane is a cation exchange membrane.

[8]

The production method according to any one of [1] to [7], in which the alkali metal for M^{B} contains sodium and/or potassium.

[9]

A method for producing vegetable oils and fats including: obtaining an alkali metal hydroxide (M^{B}-OH) and/or alkaline earth metal hydroxide (M^{C}-(OH)₂) by using, as the solution containing R^{A}—COOM^{B} and/or (R^{A}—COO)₂M^{C} and water in the production method according to any one of [1] to [8], a solution containing a soapstock generated in a deacidification process in production of vegetable oils and fats; and using the alkali metal hydroxide and/or alkaline earth metal hydroxide in the deacidification process in the production of the vegetable oils and fats.

[10]

A papermaking method including: obtaining an alkali metal hydroxide (M^{B}-OH) and/or alkaline earth metal hydroxide (M^{C}-(OH)₂) by using, as the solution containing R^{A}—COOM^{B} and/or (R^{A}—COO)₂M^{C} and water in the production method according to any one of [1] to [8], a solution containing a black liquid generated in a washing process after digestion in papermaking; and using the alkali metal hydroxide and/or alkaline earth metal hydroxide in a digestion process in the papermaking.

[11]

A method for producing a fatty acid ester including: obtaining an alkali metal hydroxide (M^{B}-OH) and/or alkaline earth metal hydroxide (M^{C}-(OH)₂) by using, as the solution containing R^{A}—COOM^{B} and/or (R^{A}—COO)₂M^{C} and water in the production method according to any one of [1] to [8], a solution containing soap wastewater generated in a washing process for a crude fatty acid ester fraction in production of a fatty acid ester; and using the alkali metal hydroxide and/or alkaline earth metal hydroxide in a crude fatty acid ester production reaction in the production of the fatty acid ester.

[12]

An apparatus for producing an alkali metal/alkaline earth metal hydroxide including: an electrochemical device that includes an anode, a cathode, and an electrolytic cell; and a cell whose inside is separated by an ion-permeable membrane, in which

with the electrochemical device, a solution containing a soapstock generated in a deacidification process in production of vegetable oils and fats is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

[13]

An apparatus for producing an alkali metal/alkaline earth metal hydroxide including: an electrolytic cell that includes an anode, a cathode, and an ion-permeable membrane separating an anode side and a cathode side, in which a solution containing a soapstock generated in a deacidification process in production of vegetable oils and fats is put into the anode side, water is put into the cathode side, and an electrochemical reaction is performed.

[14]

An apparatus for producing an alkali metal/alkaline earth metal hydroxide including: an electrolytic cell separated by an ion-permeable membrane; and an anode and a cathode disposed on one side of the electrolytic cell separated by the membrane, in which

a solution containing a soapstock generated in a deacidification process in production of vegetable oils and fats is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

[15]

An alkali metal/alkaline earth metal hydroxide recycling system including: the production apparatus according to any one of [12] to [14]; and a unit configured to supply an alkali metal hydroxide and/or alkaline earth metal hydroxide produced using the production apparatus to a deacidification process in production of vegetable oils and fats.

[16]

An apparatus for producing an alkali metal/alkaline earth metal hydroxide including: an electrochemical device that includes an anode, a cathode, and an electrolytic cell; and a cell whose inside is separated by an ion-permeable membrane, in which

with the electrochemical device, a solution containing a black liquid generated in a washing process after digestion in papermaking is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

[17]

An apparatus for producing an alkali metal/alkaline earth metal hydroxide including: an electrolytic cell that includes an anode, a cathode, and an ion-permeable membrane separating an anode side and a cathode side, in which a solution containing a black liquid generated in a washing process after digestion in papermaking is put into the anode side, water is put into the cathode side, and an electrochemical reaction is performed.

[18]

An apparatus for producing an alkali metal/alkaline earth metal hydroxide including: an electrolytic cell separated by an ion-permeable membrane; and an anode and a cathode disposed on one side of the electrolytic cell separated by the membrane, in which

a solution containing a black liquid generated in a washing process after digestion in papermaking is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

[19]

An alkali metal/alkaline earth metal hydroxide recycling system including: the production apparatus according to any one of [16] to [18]; and a unit configured to supply an alkali metal hydroxide and/or alkaline earth metal hydroxide produced using the production apparatus to a digestion process in papermaking.

[20]

An apparatus for producing an alkali metal/alkaline earth metal hydroxide including: an electrochemical device that includes an anode, a cathode, and an electrolytic cell; and a cell whose inside is separated by an ion-permeable membrane, in which

with the electrochemical device, a solution containing soap wastewater generated in a washing process for a crude fatty acid ester fraction in production of a fatty acid ester is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

[21]

An apparatus for producing an alkali metal/alkaline earth metal hydroxide including: an electrolytic cell that includes an anode, a cathode, and an ion-permeable membrane separating an anode side and a cathode side, in which a solution containing soap wastewater generated in a washing process for a crude fatty acid ester fraction in production of a fatty acid ester is put into the anode side, water is put into the cathode side, and an electrochemical reaction is performed.

[22]

An apparatus for producing an alkali metal/alkaline earth metal hydroxide including: an electrolytic cell separated by an ion-permeable membrane; and an anode and a cathode disposed on one side of the electrolytic cell separated by the membrane, in which

a solution containing soap wastewater generated in a washing process for a crude fatty acid ester fraction in production of a fatty acid ester is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}—(OH)₂ in the reaction solution is transferred into the water.

[23]

An alkali metal/alkaline earth metal hydroxide recycling system including: the production apparatus according to any one of [20] to [22]; and a unit configured to supply an alkali metal hydroxide and/or alkaline earth metal hydroxide produced using the production apparatus to a crude fatty acid ester production reaction process in production of a fatty acid ester.

### Advantageous Effects of Invention

According to the invention, there is provided a technology capable of effectively utilizing a solution containing a fatty acid salt or a derivative thereof and water as a hydrocarbon source, but also substantially the entire solution as a resource without a particularly complicated operation.

### BRIEF DESCRIPTION OF DRAWINGS

FIG. 1 is a flowchart illustrating a process for producing vegetable oils and fats.

FIG. 2 is a flowchart illustrating a process for producing a fatty acid ester.

FIG. 3 is a flowchart illustrating a papermaking process.

FIG. 4 is a diagram schematically illustrating an apparatus for producing an alkali metal/alkaline earth metal hydroxide according to an embodiment.

FIG. 5 is a diagram schematically illustrating an apparatus for producing an alkali metal/alkaline earth metal hydroxide according to another embodiment.

FIG. 6 is a diagram schematically illustrating an apparatus for producing an alkali metal/alkaline earth metal hydroxide according to yet another embodiment.

FIG. 7 is a diagram schematically illustrating an apparatus for producing an alkali metal/alkaline earth metal hydroxide according to still another embodiment.

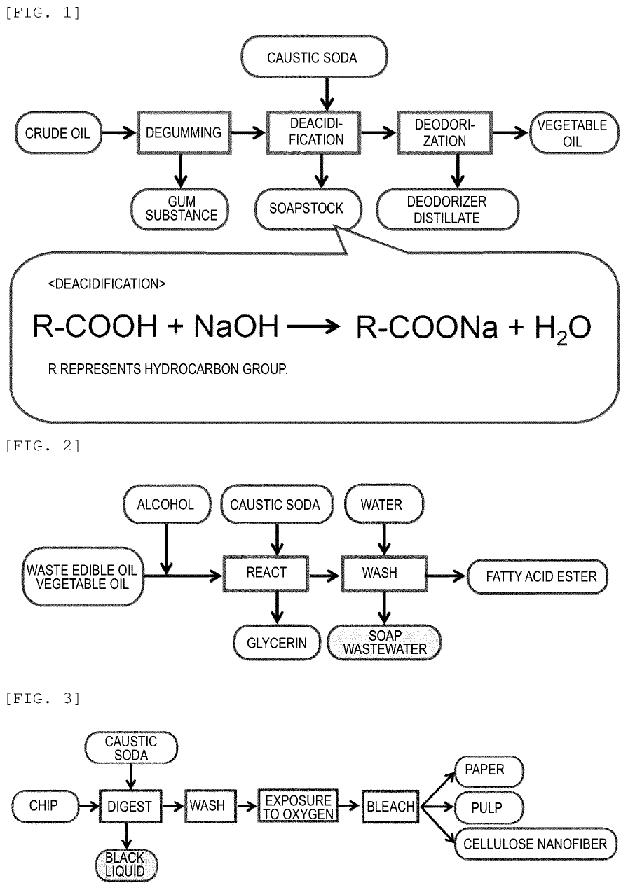

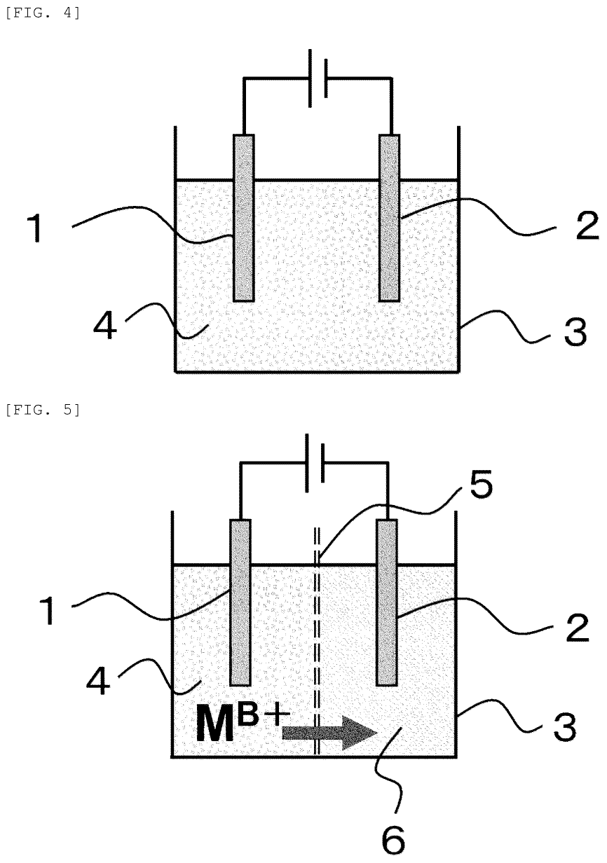

### DESCRIPTION OF EMBODIMENTS

[Method for Producing Alkali Metal/Alkaline Earth Metal Hydroxide]In one embodiment, the invention provides a method for producing an alkali metal hydroxide/alkaline earth metal. That is, the invention provides a method for producing an alkali metal/alkaline earth metal hydroxide (M^{B}-OH/M^{C}-(OH)₂) The method includes: subjecting a solution containing R^{A}—COOM^{B} and/or (R^{A}—COO)₂M^{C} and water to an electrochemical reaction to cause a Kolbe electrolysis reaction at an anode to generate at least R^{A}—R^{A}, carbon dioxide, and an M^{B+} ion and/or M^{C2+} ion; and neutralizing the M^{B+} ion and/or M^{C2+} ion by using an OH⁻ ion generated by electrolysis of water at a cathode. R^{A} represents a hydrocarbon group, M^{B} represents an alkali metal, and M^{C} represents an alkaline earth metal. The term “neutralizing” means that electrical neutrality is maintained by cations and anions.

It has not been known that an alkali metal hydroxide/alkaline earth metal hydroxide is produced by subjecting a solution containing R^{A}—COOM^{B} and/or (R^{A}—COO)₂M^{C} and water to a Kolbe electrolysis reaction, and the invention has been completed based on this new finding. That is, according to the invention, by subjecting the solution containing R^{A}—COOM^{B} and/or (R^{A}—COO)₂M^{C} and water to the Kolbe electrolysis reaction, R^{A}—R^{A}(a hydrocarbon compound) is obtained by an anode reaction, an alkali metal hydroxide and/or alkaline earth metal hydroxide is generated in the solution, and, for example, industrially useful caustic soda can be obtained. Therefore, the solution containing R^{A}—COOM^{B} and/or (R^{A}—COO)₂M^{C} and water can be effectively utilized as a resource simply by subjecting substantially the entire solution to an electrochemical reaction without performing a particularly complicated operation.

The hydrocarbon group for R^{A} may be a saturated hydrocarbon group or an unsaturated hydrocarbon group. Further, the hydrocarbon group for R^{A} may be a linear or branched aliphatic group, an aromatic hydrocarbon group, or a group obtained by combining these groups.

The hydrocarbon group for R^{A} may have a substituent. The substituent that the hydrocarbon group for R^{A} can adopt is not particularly limited. For example, sinapinic acid, coumaric acid, or caffeic acid contained in the black liquid or the like generated in the papermaking process described above are all contained in R^{A}—COOM^{B}. Therefore, representative examples of the substituent that the hydrocarbon group for R^{A} can adopt include an alkoxy group (preferably a lower alkoxy group having 1 to 3 carbon numbers, more preferably a methoxy group), a hydroxy group, and a carboxy group.

The number of carbon atoms in the hydrocarbon group for R^{A} is preferably 1 to 40, more preferably 3 to 35, still more preferably 5 to 30, and particularly preferably 8 to 25. When the hydrocarbon group has a substituent, this number of carbon atoms is the number of carbon atoms including carbon atoms in the substituent.

Examples of the alkali metal for M^{B} include lithium, sodium, potassium, rubidium, and cesium. R^{A}—COOM^{B} preferably includes a form of a sodium salt and/or a potassium salt, and is more preferably a sodium salt and/or a potassium salt. Therefore, M^{B}-OH preferably contains caustic soda (NaOH) and/or KOH, and is more preferably caustic soda and/or KOH.

Examples of the alkaline earth metal for M^{C} include beryllium, magnesium, calcium, strontium, and barium. (R^{A}—COO)₂M^{C} preferably includes a form of a magnesium salt and/or a calcium salt, and is more preferably a magnesium salt and/or a calcium salt. Therefore, M^{C}-(OH)₂ preferably contains Mg(OH)₂ and/or Ca(OH)₂, and is more preferably Mg(OH)₂ and/or Ca(OH)₂.

In the method for producing an alkali metal/alkaline earth metal hydroxide according to the invention, the solution to be subjected to the electrochemical reaction contains one or two or more compounds represented by R^{A}—COOM^{B} or (R^{A}—COO)₂M^{C}.

Specific examples of R^{A}—COOM^{B} and (R^{A}—COO)₂M^{C} include:

an alkali metal salt or an alkaline earth metal salt of a saturated fatty acid such as acetic acid, propionic acid, butyric acid, valeric acid, caproic acid, enanthic acid, caprylic acid, pelargonic acid, capric acid, lauric acid, myristic acid, palmitic acid, margaric acid, stearic acid, behenic acid, lignoceric acid, cerotic acid, montanic acid, and melissic acid;

an alkali metal salt or an alkaline earth metal salt of an unsaturated fatty acid such as palmitoleic acid, oleic acid, vaccenic acid, linoleic acid, (9,12,15)-linolenic acid, (6,9,12)-linolenic acid, eleostearic acid, arachidic acid, mead acid, arachidonic acid, nervonic acid, erucic acid, eicosapentanoic acid, docosahexaenoic acid, sorbic acid, and ricinoleic acid; and

an alkali metal salt or an alkaline earth metal salt of an aromatic group-containing carboxylic acid compound such as benzoic acid, cinnamic acid, sinapinic acid, coumaric acid, and caffeic acid.

One or two or more of these can be used.

The solution containing R^{A}—COOM^{B} and/or (R^{A}—COO)₂M^{C} and water may contain a component other than R^{A}—COOM^{B} and (R^{A}—COO)₂M^{C} and other than water as long as effects of the invention are not impaired. For example, it may contain oils and fats or a decomposition product thereof, a lignin decomposition product of a non-carboxylate, an organic solvent, an organic or inorganic salt, and the like.

A total content of R^{A}—COOM^{B} and (R^{A}—COO)₂M^{C} in the solution containing R^{A}—COOM^{B} and/or (R^{A}—COO)₂M^{C} and water can be appropriately adjusted in order to adjust a concentration of the obtained alkali metal hydroxide to a desired concentration. The total content of R^{A}—COOM^{B} and (R^{A}—COO)₂M^{C} in the solution can be appropriately adjusted within a range of, for example, 1 mass % to 90 mass %, preferably 2 mass % to 60 mass %, and more preferably 5 mass % to 50 mass %. Further, a content of water in the solution is also appropriately adjusted within a range of, for example, 10 mass % to 99 mass %, preferably 40 mass % to 98 mass %, and more preferably 50 mass % to 95 mass %.

The method for producing an alkali metal hydroxide according to the invention can be implemented in an embodiment in which the solution containing R^{A}—COOM^{B} and/or (R^{A}—COO)₂M^{C} and water contains at least one waste solution of the following (a) to (c),

(a) a soapstock generated in a deacidification process in production of vegetable oils and fats,

(b) a black liquid generated in a washing process after digestion in papermaking, and

(c) soap wastewater generated in a washing process for a crude fatty acid ester fraction in production of a fatty acid ester.

As described above, the above (a) to (c) are solutions containing R^{A}—COOM^{B} and/or (R^{A}—COO)₂M^{C} and water. In the invention, the expression “the solution containing R^{A}—COOM^{B} and/or (R^{A}—COO)₂M^{C} and water contains at least one waste solution of (a) to (c)” means that at least a part of the solution containing R^{A}—COOM^{B} and/or (R^{A}—COO)₂M^{C} and water is at least one waste solution of the above (a) to (c). For example, the solution containing R^{A}—COOM^{B} and/or (R^{A}—COO)₂M^{C} and water may be at least one waste solution of the above (a) to (c), may be a solution obtained by diluting at least one waste solution of the above (a) to (c), or may be a solution obtained by concentrating at least one waste solution of the above (a) to (c).

The method for producing an alkali metal/alkaline earth metal hydroxide according to the invention is more preferably implemented in an embodiment in which the solution containing R^{A}—COOM^{B} and/or (R^{A}—COO)₂M^{C} and water contains any one of the above (a) to (c) and does not contain the other two.

### <Electrochemical Reaction>

The electrochemical reaction in the method for producing an alkali metal hydroxide according to the invention will be described. FIG. 4 is a diagram schematically illustrating a basic configuration of an electrochemical reaction device used for the electrochemical reaction. For the electrochemical reaction device itself used in the invention, a configuration of a general electrochemical reaction device can be appropriately applied. That is, the electrochemical reaction device includes an anode 1 and a cathode 2. A material constituting the anode 1 is not particularly limited, and an anode material generally used for an electrochemical reaction can be appropriately applied. For example, platinum, stainless steel, nickel, iron, aluminum, graphite, and an aluminum/magnesium alloy (duralumin) can be used as the anode material. As a constituent material of the cathode 2, a cathode material generally used for an electrochemical reaction can be appropriately applied. For example, platinum, titanium, nickel, iron, aluminum, and graphite can be used as the cathode material.

Further, shapes of the anode 1 and the cathode 2 are not limited to specific shapes. The shapes of the anode 1 and the cathode 2 are preferably a rod shape, a plate shape, or a foil shape. The anode 1 and the cathode 2 may have a shape having holes, for example, a wire mesh shape or a mesh shape.

A state in which an electrolytic cell 3 of the electrochemical reaction device illustrated in FIG. 4 is filled with a solution 4 containing R^{A}—COOM^{B} and water, which is described above, as an electrolytic solution, will be described as an example. In this state, when a voltage is applied between the anode 1 and the cathode 2, on an anode 1 side, a Kolbe electrolysis reaction represented by the following formula (1) occurs, and at least a dimerized hydrocarbon represented by R^{A}—R^{A}, carbon dioxide, and an M^{B+} ion are generated.

2R^{A}—COOM^{B}→R^{A}—R^{A}+2CO₂+2e⁻+2M^{B+} (1)

Further, on a cathode 2 side, an electrolysis reaction of water represented by the following formula (2) occurs, and an OH⁻ ion and a hydrogen are generated.

2H₂O+2e⁻→2OH⁻+H₂ (2)

By combining the above formulas (1) and (2), a reaction formula, i.e., the following formula (3) is derived.

2R^{A}—COOM^{B}+2H₂O→R^{A}—R^{A}+2CO₂+H₂+2M^{B}OH (3)

That is, the solution 4 containing R^{A}—COOM^{B} and water is subjected to the electrochemical reaction, a Kolbe electrolysis reaction occurs at the anode 1 to generate at least a hydrocarbon, carbon dioxide, and an alkali metal ion, and the alkali metal ion is neutralized by an OH⁻ ion generated by electrolysis of water at the cathode 2 to generate an alkali metal hydroxide (M^{B}-OH).

It has been known so far that when a solution containing R^{A}—COOM^{B} and water is subjected to an electrochemical reaction, a hydrocarbon is generated at an anode. However, it has not been known how the generated M^{B+} ion behaves, that is, whether the reaction of the formula (3) actually occurs. This point will be described in more detail.

The carbon dioxide (CO₂) generated according to the formula (1) has significantly higher solubility in water than in hydrogen and oxygen. The carbon dioxide becomes a bicarbonate ion (HCO₃⁻) in a state of being dissolved in water, and it is considered to neutralize (electrically neutralize) M^{B+}. In this case, it is considered that the OH⁻ ion generated according to the formula (2) is oxidized at the anode 1 to become an oxygen molecule as in a case of general electrolysis of water. However, as a result of studies by the inventors, as illustrated in Examples described later, it has been clarified that when a solution containing R^{A}—COOM^{B} and water is subjected to an electrochemical reaction, a pH in the solution increases to pH 10 or more in several minutes while an organic synthesis reaction of hydrocarbons occurs at the anode 1, that is, an alkali metal hydroxide is generated with high efficiency by the reaction of the formula (3). If M^{B+} is neutralized by the bicarbonate ion to generate HCO₃M^{B}, the pH of the solution remains at about 8 to 9.

In the above description, the embodiment of using R^{A}—COOM^{B} is described, and the above description is also applicable to a case of using (R^{A}—COO)₂M^{C}.

The electrochemical reaction is preferably performed at 10° C. to 60° C., more preferably 15° C. to 50° C., and still more preferably 20° C. to 40° C. Further, a current density applied in the electrochemical reaction according to the invention is preferably 0.05 A/cm² to 2.00 A/cm², more preferably 0.1 A/cm² to 1.0 A/cm², and still more preferably 0.2 A/cm² to 0.6 A/cm².

Since the hydrocarbon is generated at the anode in the electrochemical reaction, the hydrocarbon can be recovered and used as a resource. That is, in a case in which the hydrocarbon generated by the Kolbe electrolysis reaction is a gas, a mixed gas containing a hydrocarbon, carbon dioxide, air, and the like can be recovered. From the recovered mixed gas, the hydrocarbon can be selectively recovered by a membrane separation method, liquefaction of hydrocarbons by compression or cooling, or the like. Further, in a case in which the hydrocarbon generated by the Kolbe electrolysis reaction is a solution or a solid, a phase separation from a hydrophilic solution containing the alkali metal hydroxide and water is caused, so that the target hydrocarbon can be easily separated and recovered.

The recovered hydrocarbon can be used as, for example, a fuel, a solder, an insulating material, a moisture-proof material, a waterproof material, an abrasive, a medication, a cosmetic, a molding material organic solvent, a wax, a lubricating oil, or an organic solvent. In a case in which the solution containing R^{A}—COOM^{B} and/or (R^{A}—COO)₂M^{C} and water contains, for example, at least one waste solution of the soapstock, the black liquid, and the soap wastewater, the recovered hydrocarbon is derived from plants, and a fuel containing the hydrocarbon is carbon neutral.

The alkali metal hydroxide generated by the electrochemical reaction can be recovered as an aqueous solution. The obtained alkali metal hydroxide aqueous solution can be appropriately subjected to concentration or impurity removal, and industrially used as a caustic soda aqueous solution or the like.

In order to obtain the alkali metal hydroxide aqueous solution as a high-purity product, an anode side and a cathode side can be separated by an ion-permeable membrane in the electrolysis reaction. By separating the two electrodes with the ion-permeable membrane, it is possible to substantially selectively move the M^{B+} ion or M^{C2+} ion to the cathode side by a concentration gradient or an electric gradient, and as a result, it is possible to increase a concentration and a purity of the alkali metal hydroxide or alkaline earth hydroxide on the cathode side as compared with the anode side. Preferred examples of such a membrane include a cation exchange membrane, a semi-permeable membrane, a cellophane membrane, and a zeolite membrane. From a viewpoint of more efficiently transferring the M^{B+} ion or M^{C2+} ion generated on the anode side to the cathode side, a cation exchange membrane is preferred.

The cation exchange membrane may be a strongly acidic cation exchange membrane or a weakly acidic cation exchange membrane. A cation exchange group in the cation exchange membrane may be in a form of having a hydrogen atom or may be in a state of being exchanged (substituted) with an alkali metal ion. In a case of using the cation exchange membrane in a state in which the cation exchange group has a hydrogen atom, when an electrochemical reaction is performed, the hydrogen atom is substituted with the M^{B+} ion or M^{C2+} ion over time, after which the M^{B+} ion or M^{C2+} ion smoothly transfers to the cathode side.

Among them, an embodiment in which in the electrochemical reaction, the anode side and the cathode side are separated by the ion-permeable membrane, the solution containing R^{A}—COOM^{B} and/or (R^{A}—COO)₂M^{C} and water is put into the anode side, water is put into the cathode side, and an electrochemical reaction is performed is preferred as the method for producing an alkali metal/alkaline earth metal hydroxide according to the invention. In such an embodiment, a high-purity alkali metal hydroxide and/or alkaline earth metal hydroxide aqueous solution can be obtained on the cathode side.

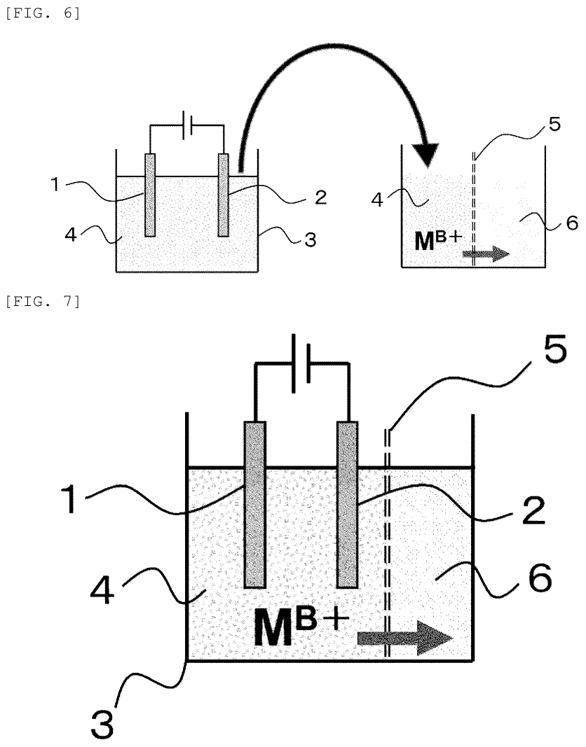

FIG. 5 schematically illustrates an embodiment in which the two electrodes are separated by an ion-permeable membrane 5, the solution 4 containing R^{A}—COOM^{B} and water is put into the anode side, water 6 is put into the cathode side, and an electrochemical reaction is performed. As illustrated in FIG. 5, the M^{B+} ion generated in the anode selectively moves to the cathode side according to the concentration gradient and is neutralized by the OH⁻ ion on the cathode side, and a high-purity alkali metal hydroxide aqueous solution is obtained on the cathode side. As the water to be put into the cathode side, tap water, distilled water, pure water, or the like can be appropriately used. Further, the “water” in the invention means that an alkali metal hydroxide, another electrolyte, and the like may be contained as long as the effects of the invention are not impaired.

Further, the method can also be implemented by an embodiment in which the electrochemical reaction is performed in the embodiment illustrated in FIG. 4, the obtained reaction solution (electrolytic solution) is put into one side of a cell whose inside is separated by an ion-permeable membrane (a cell different from an electrolytic cell), and water is put into the other side of the cell separated by the membrane. For example, FIG. 6 illustrates an embodiment in which the solution 4 containing R^{A}—COOM^{B} and water is subjected to an electrochemical reaction, and the obtained reaction solution is put into another cell. M^{B}-OH (M^{B+} ion) is transferred from one side to the other side of the another cell separated by the membrane according to the concentration gradient, and a higher-purity M^{B}-OH aqueous solution can be obtained.

Further, FIG. 7 illustrates a modification of the embodiment illustrated in FIG. 6. In an embodiment in FIG. 7, an inside of an electrolytic cell is separated by an ion-permeable membrane, both electrodes, i.e., an anode and a cathode, are disposed on one side of the electrolytic cell separated by the membrane to cause an electrochemical reaction, and water is put into the other side of the electrolytic cell separated by the membrane. Accordingly, M^{B}-OH (M^{B+} ion) generated by the electrochemical reaction is transferred to the side where water is put according to the concentration gradient, and a higher-purity M^{B}-OH aqueous solution can be obtained.

The method for producing an alkali metal/alkaline earth metal hydroxide according to the invention can be applied to a method for producing vegetable oils and fats that effectively utilizes a waste solution generated in a production process of the vegetable oils and fats. That is, according to the invention, a method for producing vegetable oils and fats is provided. The method includes: obtaining an alkali metal hydroxide and/or alkaline earth metal hydroxide by using, as the solution containing R^{A}—COOM^{B} and/or (R^{A}—COO)₂M^{C} and water, a solution containing a soapstock generated in a deacidification process in production of vegetable oils and fats; and using the alkali metal hydroxide and/or alkaline earth metal hydroxide in the deacidification process in the production of the vegetable oils and fats. In this case, the alkali metal hydroxide and/or alkaline earth metal hydroxide usually contains caustic soda (NaOH).

The expression “using, as the solution containing R^{A}—COOM^{B} and/or (R^{A}—COO)₂M^{C} and water, a solution containing a soapstock generated in a deacidification process in production of vegetable oils and fats” means that the soapstock is used as at least a part of the solution containing R^{A}—COOM^{B} and/or (R^{A}—COO)₂M^{C} and water. For example, the solution containing R^{A}—COOM^{B} and/or (R^{A}—COO)₂M^{C} and water may be the soapstock itself, a diluted product of the soapstock, or a concentrated product of the soapstock.

Further, the method for producing an alkali metal/alkaline earth metal hydroxide according to the invention can be applied to a papermaking method that effectively utilizes a waste solution generated in a papermaking process. That is, according to the invention, a papermaking method is provided. The method includes: obtaining an alkali metal hydroxide and/or alkaline earth metal hydroxide by using, as the solution containing R^{A}—COOM^{B} and/or (R^{A}—COO)₂M^{C} and water, a solution containing a black liquid generated in a washing process after digestion in papermaking; and using the alkali metal hydroxide and/or alkaline earth metal hydroxide in a digestion process in the papermaking. In this case, the alkali metal hydroxide and/or alkaline earth metal hydroxide usually contains caustic soda (NaOH).

The expression “using, as the solution containing R^{A}—COOM^{B} and/or (R^{A}—COO)₂M^{C} and water, a solution containing a black liquid generated in a washing process after digestion in papermaking” means that the black liquid is used as at least a part of a solution containing R^{A}—COOM^{B} and/or (R^{A}—COO)₂M^{C} and water. For example, the solution containing R^{A}—COOM^{B} and/or (R^{A}—COO)₂M^{C} and water may be the black liquid itself, a diluted product of the black liquid, or a concentrated product of the black liquid.

Further, the method for producing an alkali metal/alkaline earth metal hydroxide according to the invention can be applied to a method for producing a fatty acid ester that effectively utilizes a waste solution generated in a process for producing a fatty acid ester such as biodiesel. That is, according to the invention, a method for producing a fatty acid ester is provided. The method includes: obtaining an alkali metal hydroxide and/or alkaline earth metal hydroxide by using, as the solution containing R^{A}—COOM^{B} and/or (R^{A}—COO)₂M^{C} and water, a solution containing soap wastewater generated in a washing process for a crude fatty acid ester fraction in production of a fatty acid ester; and using the alkali metal hydroxide and/or alkaline earth metal hydroxide in a crude fatty acid ester production reaction in the production of the fatty acid ester. In the crude fatty acid ester production reaction, the alkali metal hydroxide and/or alkaline earth metal hydroxide acts as an alkali catalyst. The alkali metal hydroxide and/or alkaline earth metal hydroxide usually contains caustic soda (NaOH) or caustic potash (KOH).

The expression “using, as the solution containing R^{A}—COOM^{B} and/or (R^{A}—COO)₂M^{C} and water, a solution containing soap wastewater generated in a washing process for a crude fatty acid ester fraction in production of a fatty acid ester” means that the soap wastewater is used as at least a part of the solution containing R^{A}—COOM^{B} and/or (R^{A}—COO)₂M^{C} and water. For example, the solution containing R^{A}—COOM^{B} and/or (R^{A}—COO)₂M^{C} and water may be the soap wastewater itself, a diluted product of the soap wastewater, or a concentrated product of the soap wastewater.

Preferred examples of the method for producing a fatty acid ester include a method for producing a fatty acid methyl ester.

In the method for producing vegetable oils and fats, the papermaking method, and the method for producing a fatty acid ester, the obtained alkali metal hydroxide and/or alkaline earth metal hydroxide are usually in a state of an aqueous solution. The aqueous solution can be appropriately concentrated and dried and then used in each production process. Further, the alkali metal hydroxide and/or alkaline earth metal hydroxide can be used in each production process after adjusting the concentration thereof. The concentration of the alkali metal hydroxide and/or alkaline earth metal hydroxide can be adjusted by removing water from the recovered solution by heating, vacuum drying, or the like, adding water to the recovered solution of the alkali metal hydroxide and/or alkaline earth metal hydroxide, or the like.

According to the invention, in relation to the method for producing an alkali metal/alkaline earth metal hydroxide or the method for producing vegetable oils and fats, the following apparatus for producing an alkali metal/alkaline earth metal hydroxide and the following alkali metal/alkaline earth metal hydroxide recycling system using the same are provided.

That is, according to the invention, there is provided an apparatus for producing an alkali metal/alkaline earth metal hydroxide, the apparatus including: an electrochemical device that includes an anode, a cathode, and an electrolytic cell; and a cell whose inside is separated by an ion-permeable membrane. With the electrochemical device, a solution containing a soapstock generated in a deacidification process in production of vegetable oils and fats is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

Further, according to the invention, there is provided an apparatus for producing an alkali metal/alkaline earth metal hydroxide, the apparatus including: an electrolytic cell that includes an anode, a cathode, and an ion-permeable membrane separating an anode side and a cathode side. A solution containing a soapstock generated in a deacidification process in production of vegetable oils and fats is put into the anode side, water is put into the cathode side, and an electrochemical reaction is performed.

Further, according to the invention, there is provided an apparatus for producing an alkali metal/alkaline earth metal hydroxide, the apparatus including: an electrolytic cell separated by an ion-permeable membrane; and an anode and a cathode disposed on one side of the electrolytic cell separated by the membrane. A solution containing a soapstock generated in a deacidification process in production of vegetable oils and fats is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}—(OH)₂ in the reaction solution is transferred into the water.

Further, there is provided an alkali metal/alkaline earth metal hydroxide recycling system, the system including: these production apparatuses; and a unit that supplies an alkali metal hydroxide and/or alkaline earth metal hydroxide produced using these production apparatuses to a deacidification process in production of vegetable oils and fats.

A size of the apparatus for producing an alkali metal/alkaline earth metal hydroxide is appropriately designed according to a purpose.

The unit that supplies the alkali metal hydroxide and/or alkaline earth metal hydroxide to the deacidification process in the production of the vegetable oils and fats is not particularly limited, and includes any units capable of carrying the alkali metal hydroxide and/or alkaline earth metal hydroxide (usually in the state of an aqueous solution) to a site of the deacidification process in the production of the vegetable oils and fats. For example, the electrolytic cell and the site of the deacidification process are connected by a pipe, and the alkali metal hydroxide and/or alkaline earth metal hydroxide can be carried to the site of the deacidification process by circulating an alkali metal hydroxide and/or alkaline earth metal hydroxide aqueous solution in the pipe. Further, the alkali metal hydroxide and/or alkaline earth metal hydroxide aqueous solution recovered from the electrolytic cell may be carried to the site of the deacidification process by a truck, a forklift, or the like.

Further, according to the invention, in relation to the method for producing an alkali metal/alkaline earth metal hydroxide or the papermaking method, the following apparatus for producing an alkali metal/alkaline earth metal hydroxide and the following alkali metal/alkaline earth metal hydroxide recycling system using the same are provided.

That is, according to the invention, there is provided an apparatus for producing an alkali metal/alkaline earth metal hydroxide, the apparatus including: an electrochemical device that includes an anode, a cathode, and an electrolytic cell; and a cell whose inside is separated by an ion-permeable membrane. With the electrochemical device, a solution containing a black liquid generated in a washing process after digestion in papermaking is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}—(OH)₂ in the reaction solution is transferred into the water.

Further, according to the invention, there is provided an apparatus for producing an alkali metal/alkaline earth metal hydroxide, the apparatus including: an electrolytic cell that includes an anode, a cathode, and an ion-permeable membrane separating an anode side and a cathode side. A solution containing a black liquid generated in a washing process after digestion in papermaking is put into the anode side, water is put into the cathode side, and an electrochemical reaction is performed.

Further, according to the invention, there is provided an apparatus for producing an alkali metal/alkaline earth metal hydroxide, the apparatus including: an electrolytic cell separated by an ion-permeable membrane; and an anode and a cathode disposed on one side of the electrolytic cell separated by the membrane. A solution containing a black liquid generated in a washing process after digestion in papermaking is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

Further, there is provided an alkali metal/alkaline earth metal hydroxide recycling system, the system including: these production apparatuses; and a unit that supplies an alkali metal hydroxide and/or alkaline earth metal hydroxide generated on the cathode sides of these production apparatuses to a digestion process in papermaking.

A size of the apparatus for producing an alkali metal/alkaline earth metal hydroxide is appropriately designed according to a purpose.

The unit that supplies the alkali metal hydroxide and/or alkaline earth metal hydroxide to the digestion process in papermaking is not particularly limited, and includes any units capable of carrying the alkali metal hydroxide and/or alkaline earth metal hydroxide (usually in the state of an aqueous solution) to a site of the digestion process in papermaking. For example, the electrolytic cell and the site of the digestion process are connected by a pipe, and the alkali metal hydroxide and/or alkaline earth metal hydroxide can be carried to the site of the digestion process by circulating an alkali metal hydroxide and/or alkaline earth metal hydroxide aqueous solution in the pipe. Further, the alkali metal hydroxide and/or alkaline earth metal hydroxide aqueous solution recovered from the electrolytic cell may be carried to the site of the digestion process by a truck, a forklift, or the like.

Further, according to the invention, in relation to the method for producing an alkali metal/alkaline earth metal hydroxide or the method for producing a fatty acid ester, the following apparatus for producing an alkali metal/alkaline earth metal hydroxide and the following alkali metal/alkaline earth metal hydroxide recycling system using the same are provided.

That is, according to the invention, there is provided an apparatus for producing an alkali metal/alkaline earth metal hydroxide, the apparatus including: an electrochemical device that includes an anode, a cathode, and an electrolytic cell; and a cell whose inside is separated by an ion-permeable membrane. With the electrochemical device, a solution containing soap wastewater generated in a washing process for a crude fatty acid ester fraction in production of a fatty acid ester is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

Further, according to the invention, there is provided an apparatus for producing an alkali metal/alkaline earth metal hydroxide, the apparatus including: an electrolytic cell that includes an anode, a cathode, and an ion-permeable membrane separating an anode side and a cathode side. A solution containing soap wastewater generated in a washing process for a crude fatty acid ester fraction in production of a fatty acid ester is put into the anode side, water is put into the cathode side, and an electrochemical reaction is performed.

Further, according to the invention, there is provided an apparatus for producing an alkali metal/alkaline earth metal hydroxide, the apparatus including: an electrolytic cell separated by an ion-permeable membrane; and an anode and a cathode disposed on one side of the electrolytic cell separated by the membrane. A solution containing soap wastewater generated in a washing process for a crude fatty acid ester fraction in production of a fatty acid ester is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

Further, there is provided an alkali metal/alkaline earth metal hydroxide recycling system, the system including: these production apparatuses; and a unit that supplies an alkali metal hydroxide and/or alkaline earth metal hydroxide produced using these production apparatuses to a crude fatty acid ester production reaction process in production of a fatty acid ester.

A size of the apparatus for producing an alkali metal/alkaline earth metal hydroxide is appropriately designed according to a purpose.

The unit that supplies the alkali metal hydroxide to the crude fatty acid ester production reaction process in the production of the fatty acid ester is not particularly limited, and includes any units capable of carrying the alkali metal hydroxide and/or alkaline earth metal hydroxide to a site of the crude fatty acid ester production reaction process in the production of the fatty acid ester. For example, the electrolytic cell and the site of the production reaction process are connected by a pipe, and the alkali metal hydroxide and/or alkaline earth metal hydroxide can be carried to the site of the production reaction process by circulating an alkali metal hydroxide and/or alkaline earth metal hydroxide aqueous solution in the pipe. Further, the alkali metal hydroxide and/or alkaline earth metal hydroxide aqueous solution recovered from the electrolytic cell may be carried to the site of the production reaction process by a truck, a forklift, or the like.

### EXAMPLES

Hereinafter, the invention will be described in more detail based on Examples, but the invention is not limited to this form except for those defined in the invention.

### Example 1

In the electrolytic cell 3 (volume: 150 cm³) of an electrochemical reaction device having the configuration illustrated in FIG. 4 was put 100 mL (pH 8.8) of 2 mass % (0.12 mol/L) of a sodium caprylate aqueous solution as a solution containing R^{A}—COOM^{B} and water. A platinum foil was used as the anode 1, a platinum foil was used as the cathode 2, and an electrochemical reaction was performed for 15 minutes under conditions of 40° C. and a current density of 0.2 A/cm². An oil phase floated on a surface layer over time. This indicates that an organic substance such as a hydrocarbon is generated by Kolbe electrolysis. The oil phase was separated and recovered, and a change in pH of the solution in the electrolytic cell 3 was monitored. As a result, the pH of the solution increased from an initial pH of about 9 to 11 or more after 6 minutes from a start of the electrochemical reaction, and the pH at an end of the reaction (after 15 minutes from the start of the electrochemical reaction) was 12.7 (Table 1 below). That is, it was demonstrated that the alkali metal hydroxide (M^{B}-OH) was generated with high efficiency.

### Examples 2 to 7

Electrochemical reactions were performed in the same manner as in Example 1 except that, unlike in Example 1, a kind of R^{A}—COOM^{B}, a concentration of the aqueous solution thereof, a reaction temperature, and a current density were as illustrated in Table 1 below. In any of Examples 2 to 7, as in Example 1, the oil phase floated on the surface layer over time. The oil phase was separated and recovered, and a change in pH of the solution in the electrolytic cell 3 was monitored. Results are illustrated in Table 1 below.

As illustrated in Table 1 below, in any of Examples 2 to 7, it was demonstrated that the pH significantly increased in a short time in the electrochemical reaction, and the alkali metal hydroxide (M^{B}-OH) was generated with high efficiency.

TABLE 1

| | R^{A}-COOM^{B} | | | | pH | |
|---|---|---|---|---|---|---|
| | | Aqueous | | | Aqueous | |
| | | solution | Reaction | Current | solution | After |
| | | concentration | temperature | density | before | end of |
| | Kind | (mol/L) | (° C.) | (A/cm²) | reaction | reaction |
| Example 1 | Sodium caprylate | 0.12 | 40 | 0.2 | 8.8 | 12.7 |
| Example 2 | (C8) | | 10 | 0.2 | 8.9 | 12.5 |
| Example 3 | | | 50 | 0.1 | 8.2 | 11.1 |
| Example 4 | | | 50 | 0.2 | 8.2 | 13.2 |
| Example 5 | Sodium caprate | | 50 | 0.2 | 7.8 | 12.8 |
| | (C10) | | | | | |
| Example 6 | Sodium laurate | | 50 | 0.2 | 7.7 | 12.4 |
| | (C12) | | | | | |
| Example 7 | Oleic acid | | 50 | 0.2 | 7.6 | 12.1 |
| | (C18:1) | | | | | |

### Example 8

An electrochemical reaction was performed using an electrochemical reaction device having the configuration illustrated in FIG. 5. In this electrochemical reaction device, the two electrodes disposed in the electrolytic cell 3 are separated by the ion-permeable membrane 5 (trade name: Nafion NRE-212 manufactured by merck). A volume of the electrolytic cell 3 on the anode side (an anode cell) is 75 cm³, and a volume of the electrolytic cell 3 on the cathode side (a cathode cell) is also 75 cm³.

Into the anode side of the electrolytic cell 3 was put 50 mL of 2 mass % (0.12 mol/L) of a sodium caprylate aqueous solution as a solution containing R^{A}—COOM^{B} and water. Further, into the cathode side was put 50 mL of water. In this state, the pH of the solution in the anode cell was 7.8, and the pH of the solution in the cathode cell was 6.8. A platinum foil was used as the anode 1, a platinum foil was used as the cathode 2, and an electrochemical reaction was performed for 15 minutes under conditions of 50° C. and a current density of 0.2 A/cm². An oil phase was generated in a surface layer only in the anode cell over time. That is, it was confirmed that an organic substance such as a hydrocarbon was generated at the anode by Kolbe electrolysis. The oil phase was separated and recovered, and a change in pH was monitored for each solution in the anode cell and the cathode cell. As a result, at an end of the reaction (after 15 minutes from a start of the electrochemical reaction), the pH of the solution in the anode cell was 7.5, whereas the pH of the solution in the cathode cell increased greatly to 12.5 (Table 2 below). On the other hand, the solution in the cathode cell after end of the reaction was analyzed by gas chromatography, and as a result, no organic substance was detected. That is, it was seen that all the organic substances such as hydrocarbons generated by the Kolbe electrolysis remained in the anode cell.

As a reference example, when the pH was measured after 15 minutes without applying a voltage (current density: 0.0 A/cm²), almost no change in pH was observed in each solution in the anode cell and the cathode cell (Table 2 below).

As described above, it was demonstrated that by separating the two electrodes of the electrolytic cell by the membrane and performing the electrochemical reaction defined in the invention, the organic substance generated by the Kolbe electrolysis can be selectively separated into the anode cell and the alkali metal hydroxide (M^{B}-OH) can be selectively separated into the cathode cell.

TABLE 2

| | R^{A}-COOM^{B} | | | | pH | | | |
|---|---|---|---|---|---|---|---|---|
| | | Aqueous | | | Aqueous solution | | After end of | |
| | | solution | Reaction | Current | before reaction | | reaction | |
| | | concentration | temperature | density | Anode | Cathode | Anode | Cathode |
| | Kind | (mol/L) | (° C.) | (A/cm²) | cell | cell | cell | cel |
| Example 8 | Sodium | 0.12 | 50 | 0.2 | 7.8 | 6.8 | 7.5 | 12.5 |
| Reference | caprylate (C8) | | | 0.0 | 7.8 | 6.8 | 7.6 | 7.1 |
| Example | | | | | | | | |

The above results show that, by subjecting the soapstock, the black liquid, and the soap wastewater, which are solutions containing R^{A}—COOM^{B} and/or (R^{A}—COO)₂M^{C} and water, to an electrochemical reaction, an organic synthesis reaction is caused on the anode side to obtain a hydrocarbon compound containing R^{A}—R^{A}, and at the same time, an industrially useful alkali metal hydroxide and/or alkaline earth metal hydroxide can be obtained with high efficiency in the solution. Further, it can be seen that by separating the electrolytic cell with the membrane, the organic substance generated by the Kolbe electrolysis can be selectively separated into the anode cell, and the alkali metal hydroxide and/or alkaline earth metal hydroxide can be selectively separated into the cathode cell.

The invention has been described with reference to the embodiment thereof, and it is considered by the inventors that the invention is not intended to be limited in any detail of the description unless otherwise specified, and should be interpreted broadly without departing from the spirit and scope of the invention illustrated in the appended claims.

The present application is based on Japanese Patent Application No. 2021-035809 filed in Japan on Mar. 5, 2021, contents of which are incorporated herein by reference as part of the present description.

### REFERENCE SIGNS LIST

1: anode
2: cathode
3: electrolytic cell
4: solution containing R^{A}—COOM^{B} and water
5: ion-permeable membrane
6: water

1. A method for producing an alkali metal/alkaline earth metal hydroxide comprising:
subjecting a solution containing R^{A}—COOM^{B} and/or (R^{A}—COO)₂M^{C} and water to an electrochemical reaction to cause a Kolbe electrolysis reaction at an anode to generate at least R^{A}—R^{A}, carbon dioxide, and an M^{B+} ion and/or M^{C2+} ion; and neutralizing the M^{B+} ion and/or M^{C2+} ion by using an OH⁻ ion generated by electrolysis of water at a cathode, wherein
R^{A} represents a hydrocarbon group, M^{B} represents an alkali metal, and M^{C} represents an alkaline earth metal.

2. The production method according to claim 1, wherein
the solution containing R^{A}—COOM^{B} and/or (R^{A}—COO)₂M^{C} and water contains at least one waste solution of the following (a) to (c),
(a) a soapstock generated in a deacidification process in production of vegetable oils and fats,
(b) a black liquid generated in a washing process after digestion in papermaking, and
(c) soap wastewater generated in a washing process for a crude fatty acid ester fraction in production of a fatty acid ester.

3. The production method according to claim 1, wherein
a reaction solution containing M^{B}-OH and/or M^{C}-(OH)₂ generated by the neutralization is put into one side of a cell whose inside is separated by an ion-permeable membrane, water is put into the other side of the cell separated by the membrane, and the M^{B}-OH and/or M^{C}-(OH)₂ is transferred into the water.

4. The production method according to claim 1, wherein
in the electrochemical reaction, an electrolytic cell is separated by an ion-permeable membrane.

5. The production method according to claim 4, wherein
an anode side and a cathode side are separated by the membrane, the solution containing R^{A}—COOM^{B} and/or (R^{A}—COO)₂M^{C} and water is put into the anode side, water is put into the cathode side, and the electrochemical reaction is performed.

6. The production method according to claim 4, wherein
in the electrochemical reaction, the anode and the cathode are disposed on one side of the electrolytic cell separated by the membrane, M^{B}-OH and/or M^{C}-(OH)₂ is generated in a reaction solution by the electrochemical reaction, water is put into the other side of the electrolytic cell separated by the membrane, and the M^{B}-OH and/or M^{C}-(OH)₂ is transferred into the water.

7. The production method according to claim 3, wherein
the membrane is a cation exchange membrane.

8. The production method according to claim 1, wherein
the alkali metal for M^{B} contains sodium and/or potassium.

9. A method for producing vegetable oils and fats comprising:
obtaining an alkali metal hydroxide and/or alkaline earth metal hydroxide by using, as the solution containing R^{A}—COOM^{B} and/or (R^{A}—COO)₂M^{C} and water in the production method according to claim 1, a solution containing a soapstock generated in a deacidification process in production of vegetable oils and fats; and
using the alkali metal hydroxide and/or alkaline earth metal hydroxide in the deacidification process in the production of the vegetable oils and fats.

10. A papermaking method comprising:
obtaining an alkali metal hydroxide and/or alkaline earth metal hydroxide by using, as the solution containing R^{A}—COOM^{B} and/or (R^{A}—COO)₂M^{C} and water in the production method according to claim 1, a solution containing a black liquid generated in a washing process after digestion in papermaking; and
using the alkali metal hydroxide and/or alkaline earth metal hydroxide in a digestion process in the papermaking.

11. A method for producing a fatty acid ester comprising:
obtaining an alkali metal hydroxide and/or alkaline earth metal hydroxide by using, as the solution containing R^{A}—COOM^{B} and/or (R^{A}—COO)₂M^{C} and water in the production method according to claim 1, a solution containing soap wastewater generated in a washing process for a crude fatty acid ester fraction in production of a fatty acid ester; and
using the alkali metal hydroxide and/or alkaline earth metal hydroxide in a crude fatty acid ester production reaction in the production of the fatty acid ester.

12. An apparatus for producing an alkali metal/alkaline earth metal hydroxide comprising:
an electrochemical device that includes an anode, a cathode, and an electrolytic cell; and
a cell whose inside is separated by an ion-permeable membrane, wherein
with the electrochemical device, a solution containing a soapstock generated in a deacidification process in production of vegetable oils and fats is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

13. An apparatus for producing an alkali metal/alkaline earth metal hydroxide comprising:
an electrolytic cell that includes an anode, a cathode, and an ion-permeable membrane separating an anode side and a cathode side, wherein
a solution containing a soapstock generated in a deacidification process in production of vegetable oils and fats is put into the anode side, water is put into the cathode side, and an electrochemical reaction is performed.

14. An apparatus for producing an alkali metal/alkaline earth metal hydroxide comprising:
an electrolytic cell separated by an ion-permeable membrane; and
an anode and a cathode disposed on one side of the electrolytic cell separated by the membrane, wherein
a solution containing a soapstock generated in a deacidification process in production of vegetable oils and fats is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

15. An alkali metal/alkaline earth metal hydroxide recycling system comprising:
the production apparatus according to claim 12; and
a unit configured to supply an alkali metal hydroxide and/or alkaline earth metal hydroxide produced using the production apparatus to a deacidification process in production of vegetable oils and fats.

16. An apparatus for producing an alkali metal/alkaline earth metal hydroxide comprising:
an electrochemical device that includes an anode, a cathode, and an electrolytic cell; and
a cell whose inside is separated by an ion-permeable membrane, wherein
with the electrochemical device, a solution containing a black liquid generated in a washing process after digestion in papermaking is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

17. An apparatus for producing an alkali metal/alkaline earth metal hydroxide comprising:
an electrolytic cell that includes an anode, a cathode, and an ion-permeable membrane separating an anode side and a cathode side, wherein
a solution containing a black liquid generated in a washing process after digestion in papermaking is put into the anode side, water is put into the cathode side, and an electrochemical reaction is performed.

18. An apparatus for producing an alkali metal/alkaline earth metal hydroxide comprising:
an electrolytic cell separated by an ion-permeable membrane; and
an anode and a cathode disposed on one side of the electrolytic cell separated by the membrane, wherein
a solution containing a black liquid generated in a washing process after digestion in papermaking is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

19. An alkali metal/alkaline earth metal hydroxide recycling system comprising:
the production apparatus according to claim 16; and
a unit configured to supply an alkali metal hydroxide and/or alkaline earth metal hydroxide produced using the production apparatus to a digestion process in papermaking.

20. An apparatus for producing an alkali metal/alkaline earth metal hydroxide comprising:
an electrochemical device that includes an anode, a cathode, and an electrolytic cell; and
a cell whose inside is separated by an ion-permeable membrane, wherein
with the electrochemical device, a solution containing soap wastewater generated in a washing process for a crude fatty acid ester fraction in production of a fatty acid ester is subjected to an electrochemical reaction to generate M^{B}-OH and/or M^{C}-(OH)₂ in a reaction solution, the obtained reaction solution is put into one side of the cell separated by the membrane, water is put into the other side of the cell separated by the membrane, and the M^{B}-OH and/or M^{C}-(OH)₂ in the reaction solution is transferred into the water.

21. An apparatus for producing an alkali metal/alkaline earth metal hydroxide comprising:
an electrolytic cell that includes an anode, a cathode, and an ion-permeable membrane separating an anode side and a cathode side, wherein
a solution containing soap wastewater generated in a washing process for a crude fatty acid ester fraction in production of a fatty acid ester is put into the anode side, water is put into the cathode side, and an electrochemical reaction is performed.

22. An apparatus for producing an alkali metal/alkaline earth metal hydroxide comprising:
an electrolytic cell separated by an ion-permeable membrane; and
an anode and a cathode disposed on one side of the electrolytic cell separated by the membrane, wherein
a solution containing soap wastewater generated in a washing process for a crude fatty acid ester fraction in production of a fatty acid ester is put into one side of the electrolytic cell separated by the membrane, M^{B}-OH and/or M^{C}-(OH)₂ is generated in a reaction solution by an electrochemical reaction, water is put into the other side of the electrolytic cell separated by the membrane, and the M^{B}-OH and/or M^{C}-(OH)₂ in the reaction solution is transferred into the water.

23. An alkali metal/alkaline earth metal hydroxide recycling system comprising:
the production apparatus according to claim 20; and
a unit configured to supply an alkali metal hydroxide and/or alkaline earth metal hydroxide produced using the production apparatus to a crude fatty acid ester production reaction process in production of a fatty acid ester.

24. The production method according to claim 4, wherein
the membrane is a cation exchange membrane.

25. An alkali metal/alkaline earth metal hydroxide recycling system comprising:
the production apparatus according to claim 13; and
a unit configured to supply an alkali metal hydroxide and/or alkaline earth metal hydroxide produced using the production apparatus to a deacidification process in production of vegetable oils and fats.

26. An alkali metal/alkaline earth metal hydroxide recycling system comprising:
the production apparatus according to claim 14; and
a unit configured to supply an alkali metal hydroxide and/or alkaline earth metal hydroxide produced using the production apparatus to a deacidification process in production of vegetable oils and fats.

27. An alkali metal/alkaline earth metal hydroxide recycling system comprising:
the production apparatus according to claim 17; and
a unit configured to supply an alkali metal hydroxide and/or alkaline earth metal hydroxide produced using the production apparatus to a digestion process in papermaking.

28. An alkali metal/alkaline earth metal hydroxide recycling system comprising:
the production apparatus according to claim 18; and
a unit configured to supply an alkali metal hydroxide and/or alkaline earth metal hydroxide produced using the production apparatus to a digestion process in papermaking.

29. An alkali metal/alkaline earth metal hydroxide recycling system comprising:
the production apparatus according to claim 21; and
a unit configured to supply an alkali metal hydroxide and/or alkaline earth metal hydroxide produced using the production apparatus to a crude fatty acid ester production reaction process in production of a fatty acid ester.

30. An alkali metal/alkaline earth metal hydroxide recycling system comprising:
the production apparatus according to claim 22; and
a unit configured to supply an alkali metal hydroxide and/or alkaline earth metal hydroxide produced using the production apparatus to a crude fatty acid ester production reaction process in production of a fatty acid ester.
